(19) United States
(12) Patent Application Publication
(10) Pub. No.: US 2018/0189088 A1
(43) Pub. Date: Jul. 5, 2018

(54) ATTACHING A PLUGGABLE AGENT TO A VIRTUAL MACHINE (VM) IN A NETWORKED COMPUTING ENVIRONMENT

(71) Applicant: International Business Machines Corporation, Armonk, NY (US)

(72) Inventors: Li Long Chen, Beijing (CN); Kristiann J. Schultz, Chatfield, MN (US)

(21) Appl. No.: 15/396,882

(22) Filed: Jan. 3, 2017

(51) Int. Cl. G06F 9/455; G06F 17/30

(52) U.S. Cl. CPC G06F 9/45558; G06F 2009/45595; G06F 2009/45583; G06F 17/30233

(57) ABSTRACT

Aspects of the present invention provide an approach for attaching a pluggable agent to a virtual machine (VM) in a networked computing environment. In an embodiment, a VM is provisioned with a base operating system. This base operating system is a base operating system that has a file system that is adapted to run any of a plurality of agents. In response to a request for the VM to perform a service, an agent file template of an agent that is configured to perform the service on the VM is obtained. This agent is installed on the VM by modifying the file system of the provisioned base operating system to include a set of files in the agent file template.

### TECHNICAL FIELD

The subject matter of this invention relates generally to virtual computing. More specifically, aspects of the present invention provide a solution for attaching an agent to a virtual machine in a networked computing environment.

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

Providers in the networked computing environment often deliver services online via a remote server, which can be accessed via a web service and/or software, such as a web browser. Individual clients can run virtual machines (VMs) that utilize these services and store the data in the networked computing environment. This can allow a single physical server to host and/or run many VMs simultaneously.

In today's cloud world, customers may need not only virtual machines, but also managed services. These managed services can help to make sure that a server is compliant, secure, scalable, resilient for business workloads, and/or the like. Managed services are usually enabled by agents installed on the VMs. For example, an agent may be installed on the VM that monitors one or more aspects of the VM (e.g., performance, resource utilization, etc.). This agent may send information directly to a user, a system administrator, a server, a monitoring service, and/or the like. In cases in which the agent is managed by a monitoring service, the monitoring service can automatically check the status of the VM via the agent as scheduled. In the case that an irregularity is detected, an alert can be sent to the system administrator, the server, and/or others, enabling the VM to be monitored and/or managed in the cloud environment.

### SUMMARY

In general, aspects of the present invention provide an approach for attaching a pluggable agent to a virtual machine (VM) in a networked computing environment. In an embodiment, a VM is provisioned with a base operating system. In response to a request for the VM to perform a service, an agent file template of an agent that is configured to perform the service on the VM is obtained. This agent is installed on the VM by modifying the file system of the provisioned base operating system to include a set of files in the agent file template.

A first aspect of the invention provides a method for attaching a pluggable agent to a virtual machine (VM) in a networked computing environment, comprising: provisioning the VM with a base operating system, the base operating system having a file system; obtaining, in response to a request for the VM to perform a service, an agent file template of an agent that is configured to perform the service on the VM; and installing the agent on the VM by modifying the file system of the provisioned base operating system to include a set of files in the agent file template.

A second aspect of the invention provides a system for attaching a pluggable agent to a virtual machine (VM), comprising: a physical server having an operating system; at least one VM running on the physical server; an agent configured to perform a service when installed on a VM; a managed service agent manager executing on at least one computer device and being configured to: provision the VM with a base operating system, the base operating system having a file system; obtain, in response to a request for the VM to perform a service, an agent file template of an agent that is configured to perform the service on the VM; and install the agent on the VM by modifying the file system of the provisioned base operating system to include a set of files in the agent file template.

A third aspect of the invention provides a computer program product embodied in a computer readable medium that, when executed by a computer device, performs a method for attaching a pluggable agent to a virtual machine (VM) in a networked computing environment, the method comprising: provisioning the VM with a base operating system, the base operating system having a file system; obtaining, in response to a request for the VM to perform a service, an agent file template of an agent that is configured to perform the service on the VM; and installing the agent on the VM by modifying the file system of the provisioned base operating system to include a set of files in the agent file template.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a system diagram according to an embodiment of the present invention.

FIG. 5 depicts an example operating system file structure according to an embodiment of the present invention.

FIG. 6 depicts an example image file repository according to an embodiment of the present invention.

FIG. 7 depicts an example agent file template according to an embodiment of the present invention.

FIG. 8 depicts an example operating system with installed pluggable agent according to an embodiment of the present invention.

FIG. 9 depicts an example process flowchart according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, aspects of the present invention provide an approach for attaching a pluggable agent to a virtual machine (VM) in a networked computing environment. In an embodiment, a VM is provisioned with a base operating system. In response to a request for the VM to perform a service, an agent file template of an agent that is configured to perform the service on the VM is obtained. This agent is installed on the VM by modifying the file system of the provisioned base operating system to include a set of files in the agent file template.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows. On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

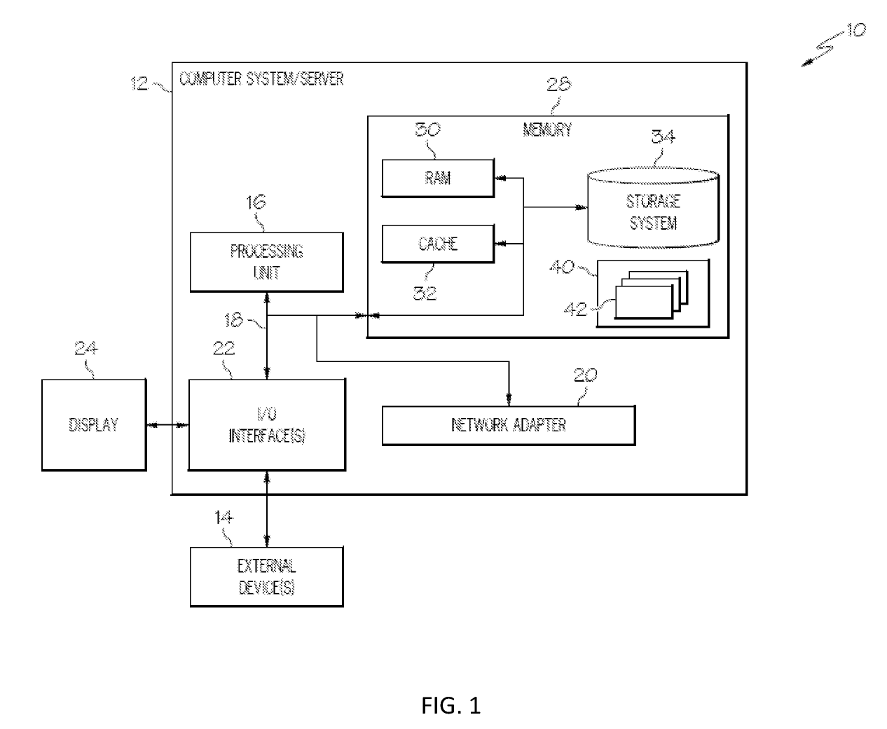

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

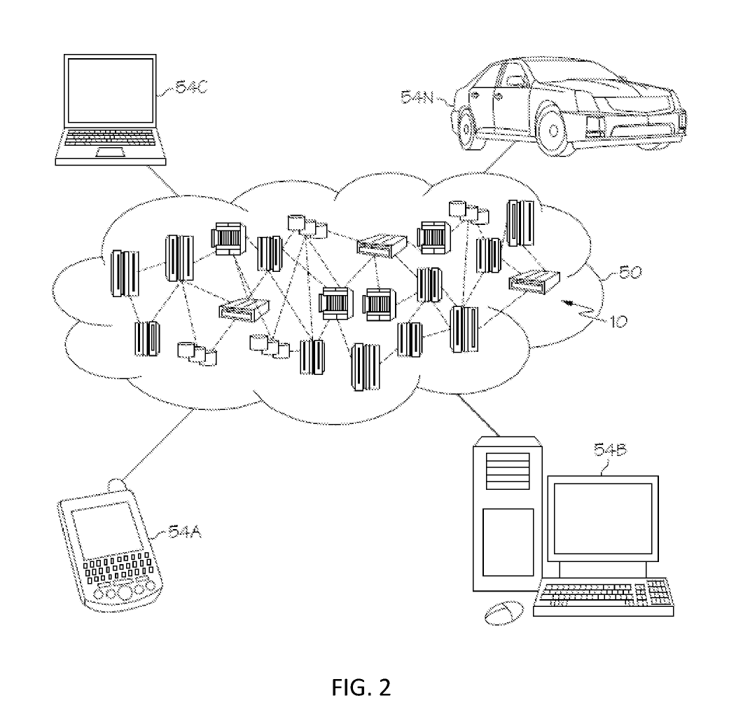

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

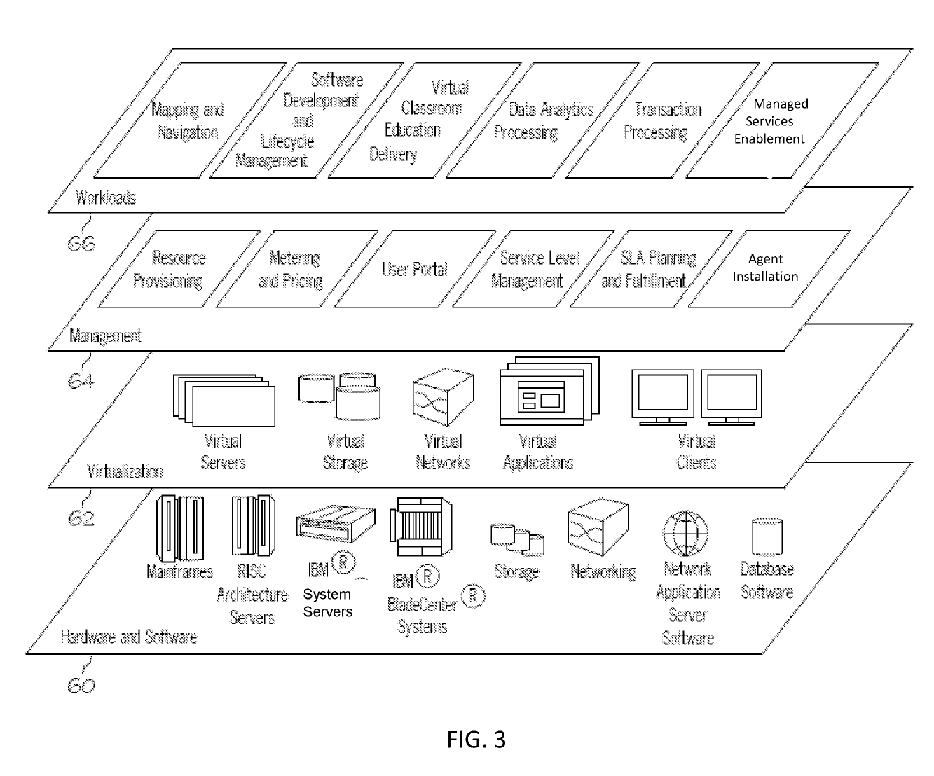

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM System X® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is agent installation, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and managed services enablement. As mentioned above, all of the foregoing examples described with respect to FIG. 3 are illustrative only, and the invention is not limited to these examples.

It is understood that all functions of the present invention as described herein typically may be performed by the command identification functionality of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

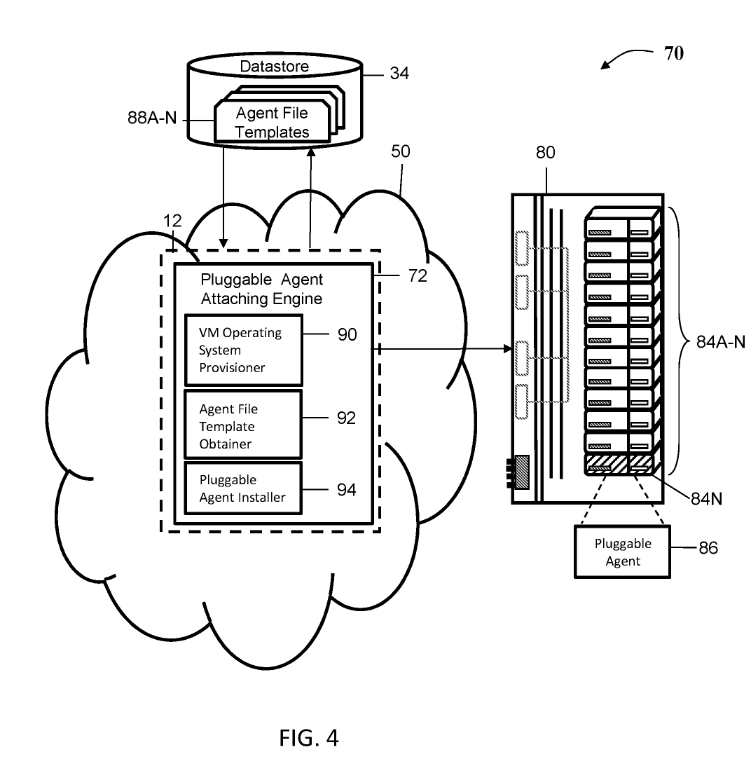

Referring now to FIG. 4, a system diagram describing the functionality discussed herein according to an embodiment of the present invention is shown. It is understood that the teachings recited herein may be practiced within any type of networked computing environment 70 (e.g., a cloud computing environment 50). A stand-alone computer system/server 12 is shown in FIG. 4 for illustrative purposes only. In the event the teachings recited herein are practiced in a networked computing environment 70, each physical server 80 need not have a pluggable agent attaching engine (hereinafter “system 72”). Rather, system 72 could be loaded on a server or server-capable device that communicates (e.g., wirelessly) with the physical server 80 to provide pluggable agent attaching therefor. Regardless, as depicted, system 72 is shown within computer system/server 12. In general, system 72 can be implemented as program/utility 40 on computer system 12 of FIG. 1 and can enable the functions recited herein. It is further understood that system 72 may be incorporated within or work in conjunction with any type of system that receives, processes, and/or executes commands with respect to IT resources in a networked computing environment. Such other system(s) have not been shown in FIG. 4 for brevity purposes.

Along these lines, system 72 may perform multiple functions similar to a general-purpose computer. Specifically, among other functions, system 72 can attach a pluggable agent 86 to a VM 84A-N in a networked computing environment 70. To accomplish this, system 72 can include: a VM operating system provisioner 90, an agent file template obtainer 92, and pluggable agent installer 94.

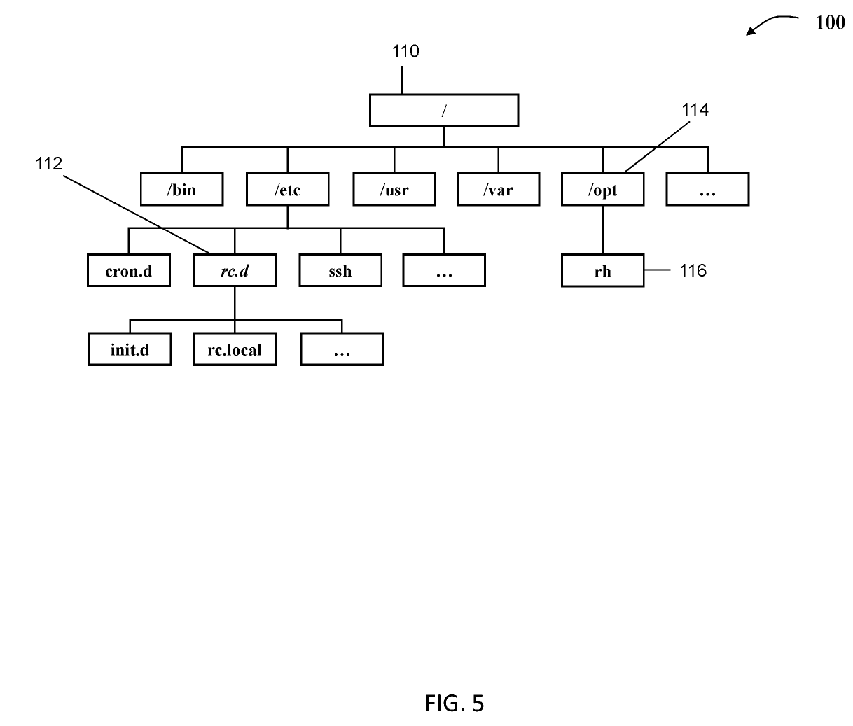

Referring now to FIG. 5 in conjunction with FIG. 4, an example operating system file structure 100 is shown according to an embodiment of the invention. In an embodiment, operating system file structure 100 includes a root directory 110 and a number of child directories and files. It should be understood that the labels and structures of operating system file structure 100 in FIG. 5 are only illustrative and that other file structures, configurations, names, etc. are envisioned. To this extent, operating system file structure 100 can be thought of as representing the file structure of any operating system (e.g., AIX, Linux, Windows, and/or the like) that can be utilized by a VM in performing its tasks. In any case, the operating system represented by operating system file structure 100 is a base operating system that has not had an agent installed.

The inventors of the invention described herein have discovered certain deficiencies in the current solutions for installing an agent (e.g., so as to enable a managed service) on a particular VM 84N. For example, in one current solution the operating system and agent are bundled together into one image. In this solution, whenever a particular agent is needed to execute on a specific operating system, an image that has a combination of the operating system and the agent is built. For example, a Chef agent running on a Linux operating system can be built into an image. However, this solution has several drawbacks. For example, as the number of agents and the number of operating systems increases, the number of combinations of agent and OS increase multiplicatively, requiring large amounts of storage to store all of the image combinations. Further, an upgrade of either the agent or the operating system requires every image that includes the upgraded component to be rebuilt. In addition, the availability of these bundled images for reuse is limited due to the fact that neither the operating system nor the agent can be repurposed separately.

Another current solution involves installing the agents with scripts during provisioning of the VM 84N. However, it is usually desirable to minimize provisioning time, and executing installation scripts during provisioning can be time consuming. This can be particularly resource intensive in a large-scale environment in which a large number of VMs 84A-N with managed services need to be provisioned. Further, the scripts themselves are software which must be developed, debugged, and maintained. As such, the scripts themselves can introduce errors into the process. These challenges are increased in cases where there a number of different environments in which the scripts must operate. Further, if the environment or other requirements change, a large effort may be needed in order to update or maintain the install scripts.

To this extent, in the current invention as illustrated in FIGS. 4 and 5, VM operating system provisioner 90 of system 72, as executed by computer system/server 12, is configured to provision VM 84N with a base operating system. This base operating system can be any base operating system (e.g., AIX, Linux, Windows, etc.) that would typically be used in conjunction with a VM 84N. However, in contrast to solutions that bundle an operating system and agent, the operating system that is provisioned by VM operating system provisioner 90 does not require modification prior to provisioning. Rather, the base operating system can be provisioned and then any of a plurality of pluggable agents 86 can subsequently be installed and executed as will be described.

It should be understood that VMs 84A-N are different from a process virtual machine. A process virtual machine is a platform dependent engine, such as a Java® Virtual Machine, that executes platform independent code written in a high-level programming language, such as Java, for performing a specific task (Java and Java Virtual Machine are trademarks of Oracle and/or its affiliates in the United States and/or elsewhere). In contrast, the VMs 84A-N of the current invention are each virtual systems that can simulate an entire computing environment. To this extent, rather than performing only a single task, the VMs of the current invention can be environments within which a variety of tasks, functions, operations, etc., can be carried out by a user, such as by executing one or more applications and/or managed services thereon. As such, a plurality of VMs 84A-N can operate independently on a single physical server 80, while each of VMs 84A-N can be made to simulate a stand-alone computer system in the eyes of a user.

Referring again to FIG. 4, agent file template obtainer 92 of system 72, as executed by computer system/server 12, is configured to obtain an agent file template 88A-N of a pluggable agent 86 that is configured to perform the service on the VM 84N. Specifically, if a request is made for VM 84N to perform a particular service, agent file template obtainer 92 determines which agent is needed to perform the requested service. Agent file template obtainer 92 can then retrieve an agent file template 88N that corresponds to the requested service and the operating system that has been provisioned in VM 84N. In an embodiment, the agent file templates can be stored in an image repository (e.g., in datastore 34). When the request is made, agent file template obtainer 92 can select the necessary agent file template 88N from among the plurality of agent file templates 88A-N in the image repository based on the base operating system and the requested service specified in the request.

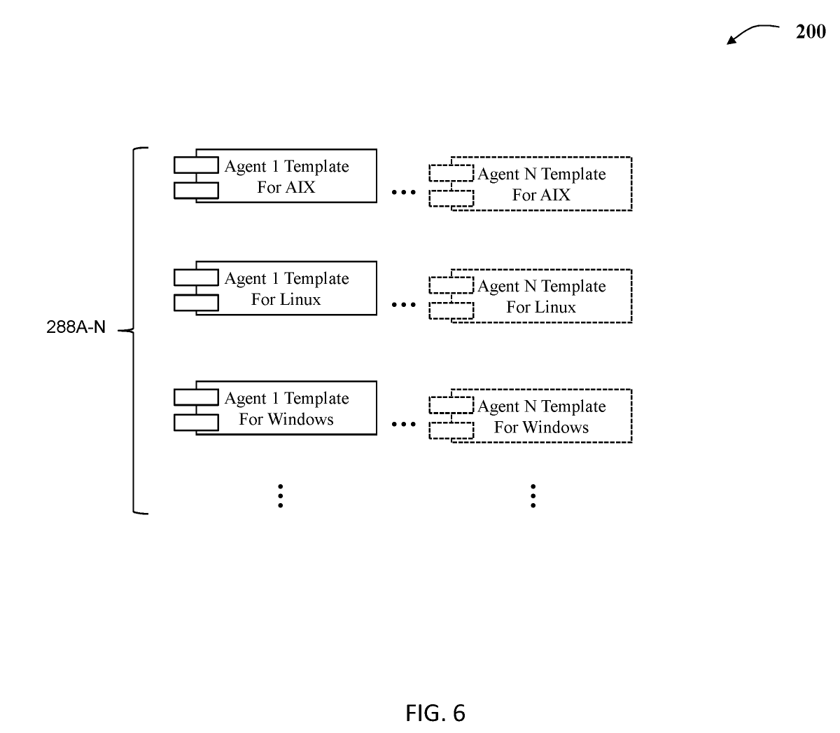

Referring now to FIG. 6, an example image repository 200 is shown according to embodiments of the invention. As shown, image file repository 200 has a number of agent file templates 88A-N. Each agent file template 88A-N in image file repository 200 can be used to enable a particular agent (e.g., agent 1 . . . agent N) on a particular operating system (e.g., AIX, Linux, Windows, etc.).

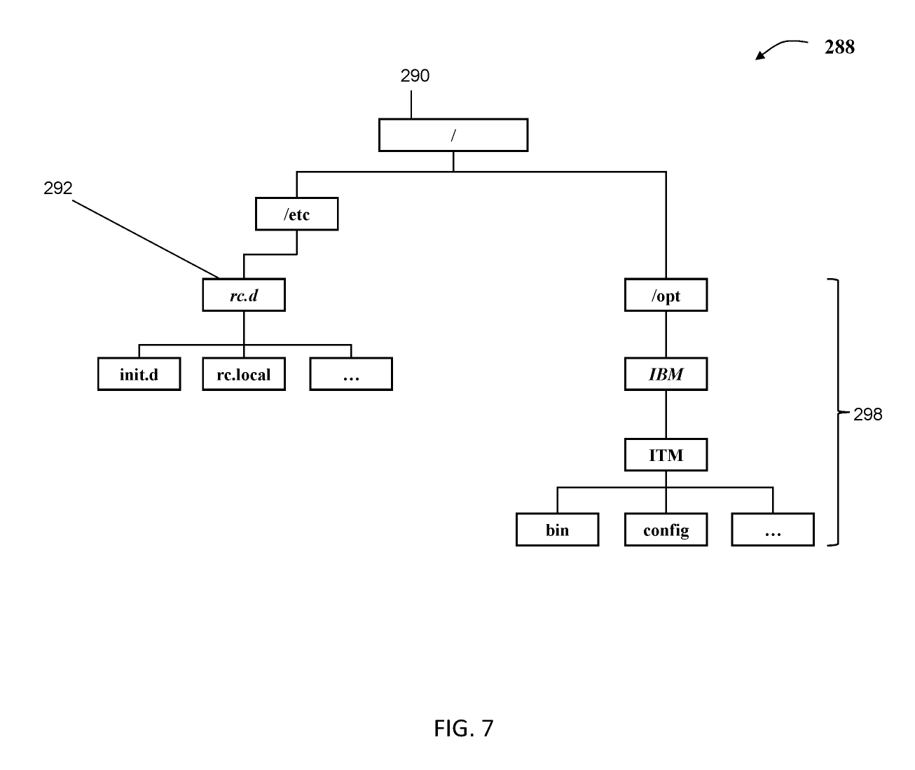

Referring now to FIG. 7 in conjunction with FIG. 5, an example agent file template 288 is shown according to embodiments of the invention. As illustrated, similar to base operating system file system 100, agent file template 288 has a file system with a root node 290 and a number of child directories and/or files. Agent file template 288 may have a number of files and/or directories in common with base operating system file system 100, such as the rc.d file 112/292 illustrated in FIGS. 5 and 7. However, agent file template 288 has the files necessary to install the agent on a VM 84A-N having the corresponding operating system. To this extent, agent file template 288 may also have a section 298 that has enabling files that are not included in base operating system file system 100. Further, as agent file template 288 is not meant to be a bundled operating system and agent combination, files that are only used in the base operating system are not included. Thus, space can be saved in storage, which would not be available using a bundled solution.

Using the teachings of the current invention, an agent file template 288 for a particular pluggable agent 86 (FIG. 4) can be created for use with any base operating system. In an embodiment, the agent is installed on the operating system and the operating system is provisioned using any solution. Next, an empty file system is union mounted to the base operating system image. Then the file system of the agent-installed operating system is compared with the base operating file system 100. Any differences between the two are put into the new file system union mounted and the result is the agent file template 288. For example, as illustrated, agent file template 288 indicates that the installation of the agent on the base operating system included changes to the rc.d file 112. As such, the version of the rc.d file 292 in the agent-installed operating system is stored in agent file template 288. Similarly, the comparison showed that section 298 is included in the agent-installed operating system but not in the base operating system. Accordingly, the file structure of this section 298 is stored within agent file template 288.

Referring again to FIG. 4, pluggable agent installer 94 of system 72, as executed by computer system/server 12, is configured to obtain an agent file template 88A-N of a pluggable agent 86 that is configured to install the pluggable agent 86 on the VM 84N. This can be accomplished by modifying the file system of the already provisioned base operating system to include the set of files in the selected agent file template 88N. To attach pluggable agent 86 to provisioned VM 84N, agent file template 88N is union mounted to base operating system file structure 100. For example, any folders and/or files that are present in agent file template 88N but are not present in base operating system file structure 100 are simply copied into the combined file structure. Further, any files that are different between base operating system file structure 100 and agent file template 88N are copied from agent file template 88N into the combined file structure.

Because the file resulting structure of the agent file template 88N follows that of the base operating system file system 100, agent file template 88N can be easily merged with base operating system file system 100 after the base operating system has been provisioned. Further, because the agent file template 88N was created based on an agent-installed operating system, the result of the merging is the agent-installed operating system. This process also allows the pluggable agent to be detached from the base operating file system when it is no longer needed, allowing the components to be reused. For example, an unmount operation can be used to remove the previously installed elements of the agent file template 88N, yielding the base operating file system. Specifically, the file structure of the combined file structure can be compared with agent file template 88N, and common files can be removed using a union merge. Alternatively, the base operating file system can be compared with the combined file structure, and any files that are different can be removed with a union merge operation.

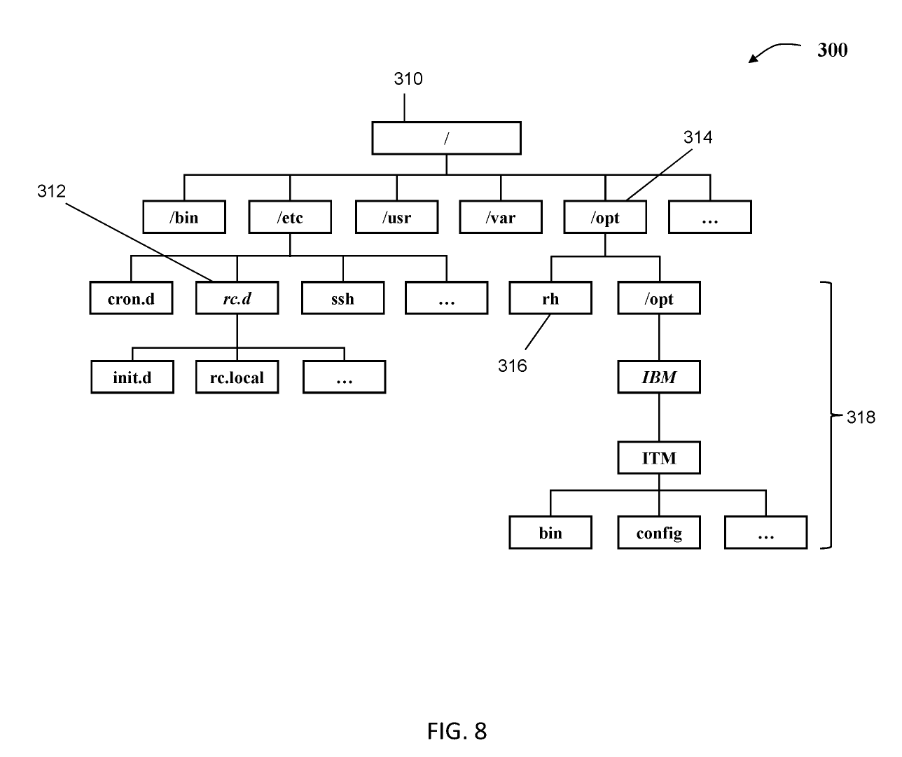

Referring now to FIG. 8, in conjunction with FIGS. 5 and 7, an example operating system with installed pluggable agent 300 is illustrated according to embodiments of the present invention. As can be seen, the operating system with installed pluggable agent 300 has all of the files/folders included in base operating system file structure 100. In addition, section 298 of agent file template 288 has been included as new section 318. Further, rc.d file 112 from base operating system file structure 100 has been replaced by rc.d file 292 in agent file template 288 to yield new rc.d file 312.

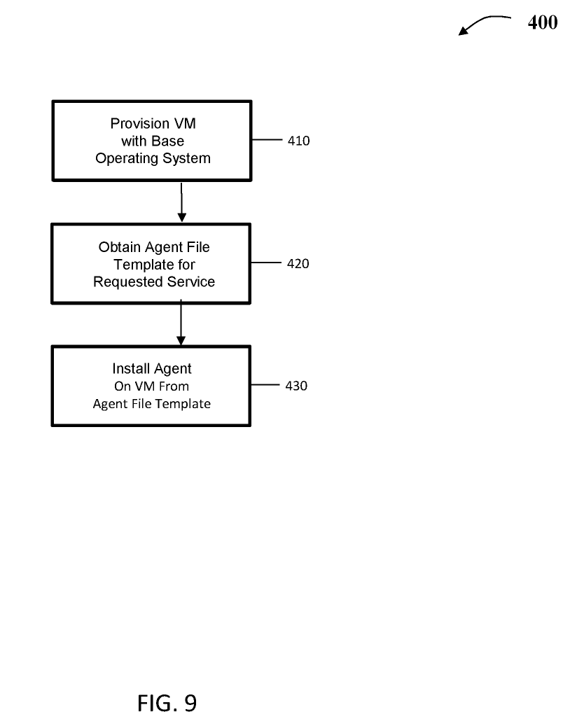

Referring now to FIG. 9 in conjunction with FIG. 4, a process flowchart according to an embodiment of the present invention is shown. At 410, VM operating system provisioner 90 of system 72, as executed by computer system/server 12, provisions VM 84N with base operating system. At 420, agent file template obtainer 92 obtains an agent file template 88N for a requested service. At 430, pluggable agent installer 94, installs the pluggable agent 86 on the VM 84N from the agent file template 88N.

The process flowchart of FIG. 9 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

While shown and described herein as an approach for attaching a pluggable agent to a virtual machine (VM) in a networked computing environment, it is understood that the invention further provides various alternative embodiments. For example, in one embodiment, the invention provides a method that performs the process of the invention on a subscription, advertising, and/or fee basis. That is, a service provider, such as a Solution Integrator, could offer to provide functionality for attaching a pluggable agent to a VM. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In another embodiment, the invention provides a computer-implemented method for attaching a pluggable agent to a VM in a networked computing environment. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, system 72 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for responding to a threat in a networked computing environment. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for attaching a pluggable agent to a virtual machine (VM) in a networked computing environment, comprising:
provisioning the VM with a base operating system, the base operating system having a file system;
obtaining, in response to a request for the VM to perform a service, an agent file template of an agent that is configured to perform the service on the VM; and
installing the agent on the VM by modifying the file system of the provisioned base operating system to include a set of files in the agent file template.

2. The method of claim 1, wherein the service is a managed service and wherein the agent enables the managed service on the VM.

3. The method of claim 1, wherein the agent file template is a difference between the operating system with the agent installed and the base operating system; and wherein the installing further comprises copying a file structure of the agent file template into the file system of the base operating system.

4. The method of claim 2, further comprising:
removing the agent from the VM by modifying the file system of the provisioned base operating system with the installed agent to remove the set of files in the agent file template; and
using the provisioned base operating system without the agent.

5. The method of claim 1, wherein the obtaining further includes selecting the agent file template from among a plurality of agent file templates in an image repository based on the base operating system and the requested service.

6. The method of claim 1, wherein each agent file template of the plurality of agent file templates corresponds to a unique combination of a service and a base operating system.

7. The method of claim 1, wherein the networked computing environment is a cloud computing environment and wherein the VM is a cloud resource.

8. A system for attaching a pluggable agent to a virtual machine (VM), comprising:
a physical server having an operating system;
at least one VM running on the physical server;
an agent configured to perform a service when installed on a VM; and
a managed service agent manager executing on at least computer device and being configured to:
provision the VM with a base operating system, the base operating system having a file system;
obtain, in response to a request for the VM to perform a service, an agent file template of an agent that is configured to perform the service on the VM; and
install the agent on the VM by modifying the file system of the provisioned base operating system to include a set of files in the agent file template.

9. The system of claim 8, wherein the service is a managed service and wherein the agent enables the managed service on the VM.

10. The system of claim 8, wherein the agent file template is a difference between the operating system with the agent installed and the base operating system, and wherein the installing further comprises copying a file structure of the agent file template into the file system of the base operating system.

11. The system of claim 10, the managed service agent manager further being configured to:
remove the agent from the VM by modifying the file system of the provisioned base operating system with the installed agent to remove the set of files in the agent file template; and
use the provisioned base operating system without the agent.

12. The system of claim 8, wherein the obtaining further includes selecting the agent file template from among a plurality of agent file templates in an image repository based on the base operating system and the requested service.

13. The system of claim 8, wherein each agent file template of the plurality of agent file templates corresponds to a unique combination of a service and a base operating system.

14. The system of claim 8, wherein the networked computing environment is a cloud computing environment and wherein the VM is a cloud resource.

15. A computer program product embodied in a computer readable medium that, when executed by a computer device, performs a method for attaching a pluggable agent to a virtual machine (VM) in a networked computing environment, the method comprising:
provisioning the VM with a base operating system, the base operating system having a file system;
obtaining, in response to a request for the VM to perform a service, an agent file template of an agent that is configured to perform the service on the VM; and
installing the agent on the VM by modifying the file system of the provisioned base operating system to include a set of files in the agent file template.

16. The program product of claim 15, wherein the service is a managed service and wherein the agent enables the managed service on the VM.

17. The program product of claim 15, wherein the agent file template is a difference between the operating system with the agent installed and the base operating system, and wherein the installing further comprises copying a file structure of the agent file template into the file system of the base operating system.

18. The program product of claim 15, wherein the obtaining further includes selecting the agent file template from among a plurality of agent file templates in an image repository based on the base operating system and the requested service.

19. The program product of claim 15, wherein each agent file template of the plurality of agent file templates corresponds to a unique combination of a service and a base operating system.

20. The program product of claim 15, the method further comprising:
removing the agent from the VM by modifying the file system of the provisioned base operating system with the installed agent to remove the set of files in the agent file template; and
using the provisioned base operating system without the agent.
